(19) United States
(12) Patent Application Publication
(10) Pub. No.: US 2025/0364826 A1
(43) Pub. Date: Nov. 27, 2025

(54) CHARGING CONTROL METHOD AND CHARGING CONTROL DEVICE FOR BATTERY MANAGEMENT SYSTEM

(71) Applicant: LIAN ZHENG ELECTRONICS (SHENZHEN) CO., LTD., GUANGDONG (CN)

(72) Inventors: Zicheng FENG, GUANGDONG (CN); YINZHUO CHEN, GUANGDONG (CN); Hu QIN, GUANGDONG (CN)

(21) Appl. No.: 19/071,169

(22) Filed: Mar. 5, 2025

(30) Foreign Application Priority Data
Mar. 8, 2024 (CN) 202410268636.8
Apr. 24, 2024 (CN) 202410501107.8

(51) Int. Cl. H02J 7/00; H02J 7/34

(52) U.S. Cl. CPC H02J 7/00714; H02J 7/00304; H02J 7/0031; H02J 7/007182; H02J 7/007194; H02J 7/342

(57) ABSTRACT

The disclosure provides a charging control method and a charging control apparatus for a battery management system. The control method includes: selecting, based on a charging state of the BMS, to enter a corresponding charging mode. The charging mode includes a high-current charging mode, a float charging mode, a stop charging mode, and a protection charging mode. During an initial set time after the BMS starts operating, the BMS operates in the protection charging mode. In the protection charging mode, a battery is charged within a protection charging current threshold. After the initial set time ends, one of the protection charging mode, the high-current charging mode, the float charging mode, and the stop charging mode is selected for entry based on the charging state of the BMS. The disclosure resolves a problem of damage to a plurality of BMSs with different voltages or capacities caused by a relatively high circulating current generated when the BMSs are connected in parallel.

### TECHNICAL FIELD

The disclosure belongs to the field of battery management technologies, and in particular, to a charging control method and a charging control apparatus for a battery management system.

### BACKGROUND

With the continuous development of battery technologies, an increasing number of devices (for example, an electric vehicle or a UPS) use batteries as energy storage modules. In a use process of a battery, if overcharging or over-discharging occurs, the lifespan of the battery is affected. In a serious case, this may lead to a severe safety accident such as a battery fire explosion. Therefore, a battery management system (BMS) is typically deployed to intelligently manage and maintain individual battery cells. The BMS serves as a central hub for managing and monitoring power batteries, which is used to manage, maintain, and monitor battery modules, and is responsible for preventing overcharging and over-discharging of the batteries, extending the lifespans of the batteries, and helping the batteries to operate normally.

The BMS is a system that combines software and hardware, and is usually powered by a battery. Therefore, while managing and monitoring the battery, the BMS continuously consumes energy of the battery. In existing BMS charging solutions, a corresponding charging design is not performed for a plurality of cases encountered in a BMS charging process, and there are many problems in use.

Therefore, there is an urgent need for a BMS charging solution with multi-protection functions to resolve the foregoing problems.

### SUMMARY

Therefore, an objective of the disclosure is to overcome the foregoing disadvantages of the conventional technology, and provide a charging control method and a charging control apparatus for a battery management system.

According to a first aspect, the disclosure provides a charging control method for a battery management system. The control method selects, based on a charging state of the battery management system, a corresponding charging mode for operating, the charging mode including a high-current charging mode, a float charging mode, and a stop charging mode, where the charging mode further includes a protection charging mode, and in the protection charging mode, a battery is charged within a protection charging current threshold; and the control method includes: during an initial set time when the battery management system starts operating, operating the battery management system in the protection charging mode; and after the initial set time when the battery management system starts operating, selecting, based on the charging state of the battery management system, to enter one of the protection charging mode, the high-current charging mode, the float charging mode, and the stop charging mode.

Preferably, the selecting, based on the charging state of the battery management system, to enter one of the protection charging mode, the high-current charging mode, the float charging mode, and the stop charging mode includes: before selecting to enter the high-current charging mode, determining whether to enter the protection charging mode.

Preferably, the selecting, based on the charging state of the battery management system, to enter one of the protection charging mode, the high-current charging mode, the float charging mode, and the stop charging mode includes: determining, based on the charging state of the battery management system, whether a stop charging condition is met, and if the stop charging condition is met, entering the stop charging mode; or if the stop charging condition is not met, further determining whether a float charging condition is met; if the float charging condition is met, entering the float charging mode; or if neither the stop charging condition nor the float charging condition is met, further determining whether a protection charging condition is met; and if the protection charging condition is met, entering the protection charging mode; or if the stop charging condition, the float charging condition, and the protection charging condition are not met, entering the high-current charging mode.

Preferably, after the selecting, based on the charging state of the battery management system, to enter one of the protection charging mode, the high-current charging mode, the float charging mode, and the stop charging mode, the charging control method includes: in a current charging mode selected for entry, returning to perform, by the battery management system at a set time interval, the step of determining, based on the charging state of the battery management system, whether a stop charging condition is met.

Preferably, the determining whether a protection charging condition is met includes: when a charging current is less than a first charging current threshold, entering the protection charging mode; where the first charging current threshold is determined based on the protection charging current threshold.

Preferably, the determining whether a protection charging condition is met further includes: when a charging current is greater than a high-current charging current threshold, entering the protection charging mode; where the high-current charging current threshold is a maximum charging current value set in the high-current charging mode.

Preferably, after entering the protection charging mode, the charging control method exits the protection charging mode, and returns to the step of determining, based on the charging state of the battery management system, whether a stop charging condition is met, if the protection charging condition is no longer met.

Preferably, in the float charging mode, when a charging current is greater than a float charging current threshold by a first set difference, it is determined that a fault occurs to a charging circuit is faulty, and the charging circuit is controlled to be disconnected; and/or in the protection charging mode, when a charging current is greater than the protection charging current threshold by a second set difference, it is determined that a fault occurs to a charging circuit, and the charging circuit is controlled to be disconnected.

Preferably, the stop charging condition includes at least one of the following conditions: a cell voltage is excessively high, a battery is fully charged, an average cell voltage is excessively high, a cell temperature is excessively high, and the cell temperature is excessively low.

Preferably, the determining whether a float charging condition is met includes: when a maximum single cell voltage is greater than a first single cell voltage threshold, the float charging condition being met; and after the float charging condition is met, if a release condition corresponding to the float charging condition exists, exiting the float charging mode, and returning to the step of determining, based on the charging state of the battery management system, whether a stop charging condition is met; where the release condition corresponding to the float charging condition includes: the maximum single cell voltage is less than a second single cell voltage threshold; where the first single cell voltage threshold is greater than the second single cell voltage threshold.

According to a second aspect, the disclosure provides a charging control apparatus for a battery management system, including: a controllable fuse, a battery, and a high-current charging switch that are disposed between a positive terminal and a negative terminal of the battery management system, a protection charging module connected in parallel to two ends of the high-current charging switch, and a float charging module connected in parallel to the two ends of the high-current charging switch; where the controllable fuse is configured to stop charging of the battery management system when a fault occurs to the charging; the high-current charging switch is a semiconductor switching device, and is configured to control a maximum charging current to fall within a set high-current threshold range; the protection charging module is configured to control the maximum charging current to fall within a set protection charging current threshold; the float charging module is configured to control the maximum charging current to fall within a set float charging current threshold; and the controllable fuse, the high-current charging switch, the protection charging module, and the float charging module are controlled to be turned on or turned off by the battery management system, and only one of the high-current charging switch, the protection charging module, and the float charging module can be turned on at a same time.

Compared with the conventional technology, the charging control method of the disclosure can enter a corresponding charging mode based on the charging state in a BMS charging process, and is set to enter the protection charging mode by default when the BMS starts operating, thereby resolving a problem of damage to a plurality of BMSs with different voltages or capacities caused by a relatively high circulating current generated when the BMSs are connected in parallel. The disclosure further resolves a problem of BMS overcharging caused by a short circuit of a sampling circuit or a short circuit of a charging circuit, and a high-current charging current limit value can be conveniently modified without changing hardware, so that a charging control solution is more flexible.

### BRIEF DESCRIPTION OF THE DRAWINGS

The following further describes the embodiments of the disclosure with reference to the accompanying drawings, where:

FIG. 1 is a structural diagram of a charging control apparatus for a battery management system according to an embodiment of the disclosure;

FIG. 2 is a charging sequence diagram of a BMS according to an embodiment of the disclosure;

FIG. 3 is a schematic diagram of a mode switching logic according to an embodiment of the disclosure;

FIG. 4 is a result diagram of a UL test performed by using an existing BMS charging solution; and

FIG. 5 is a result diagram of a UL test performed by using a BMS charging solution according to an embodiment of the disclosure.

### DETAILED DESCRIPTION

To make the objectives, technical solutions, and advantages of the disclosure clearer, the following further describes the disclosure in detail through the embodiments with reference to the accompanying drawings. It should be understood that the embodiments described herein are only used to explain the disclosure, and are not intended to limit the disclosure.

An existing BMS charging solution generally includes two modes: a high-current charging mode and a float charging mode. After the BMS starts operating, the BMS first enters the high-current charging mode, to control charging a battery within a set high-current charging current threshold. When a cell voltage of the battery reaches a certain degree (that is, when a float charging condition is met), the BMS enters the float charging mode, to continuously charge the battery within a relatively small float charging current threshold until the battery is fully charged. After research, the inventor found that in an existing BMS charging solution, a corresponding charging design is not performed on a plurality of cases encountered in a BMS charging process, and there are a plurality of problems in application. For example, a sampling circuit is short-circuited and a current cannot be collected, thereby causing BMS overcharging; a charging circuit is short-circuited, thereby causing BMS overcharging; damage is caused to one or more BMSs due to a relatively large circulating current caused by a large voltage difference when a plurality of BMSs with different voltages or capacities are connected in parallel; and changing the maximum charging current requires changing a hardware circuit (that is, redesigning working logic). To resolve the foregoing problems, the inventor proposes a charging control apparatus and control method for a BMS. The following describes the content of the disclosure with reference to specific embodiments.

FIG. 1 is a structural diagram of a charging control apparatus for a battery management system according to an embodiment of the disclosure. According to this embodiment of the disclosure, the charging control apparatus includes: a controllable fuse 1 disposed between a positive terminal P+ of the BMS and a negative terminal P− of the BMS, a battery 2, a high-current charging switch 4, a protection charging circuit (shown only schematically in FIG. 1) and a protection charging switch 5 thereof that are connected in parallel to two ends of the high-current charging switch 4, and a float charging circuit (shown only schematically in FIG. 1) and a float charging switch 3 thereof that are connected in parallel to the two ends of the high-current charging switch 4, where the protection charging circuit and the protection charging switch 5 thereof constitute a protection charging module, and the float charging circuit and the float charging switch 3 thereof constitute a float charging module. Whether the controllable fuse 1 is fused is controlled by a microcontroller MCU inside the BMS, and the controllable fuse is configured to stop charging and discharging of the BMS when a fault occurs to the charging, to isolate the battery management system to which a fault occurs from another device. After the float charging switch 3 is turned on, the float charging circuit controls a maximum charging current to be limited within a set float charging current threshold, and the MCU controls the float charging switch 3 to be turned on or turned off. The high-current charging switch 4 is a semiconductor switching device, and includes a metal-oxide semiconductor field-effect transistor (MOSFET) or an insulated gate bipolar transistor (IGBT) each of which includes an anti-parallel parasitic diode or a body diode. The high-current charging switch 4 is configured to control to charge within a set high-current threshold range, and the MCU is responsible for controlling the high-current charging switch 4 to be turned on or turned off. After the protection charging switch 5 is turned on, the protection charging circuit controls the maximum charging current to be limited within a set protection charging current threshold, and the MCU controls the protection charging switch 5 to be turned on or turned off. At a same time, only one of the high-current charging switch 4, the protection charging switch 5, and the float charging switch 3 is controlled to be turned on by the MCU.

In some embodiments, the controllable fuse 1 is disposed between the positive terminal P+ of the BMS and a positive terminal of the battery 2, and the protection charging module including the protection charging switch 5, the float charging module including the float charging switch 3, and the high-current charging switch 4 are disposed between the negative terminal P− of the BMS and a negative terminal of the battery 2.

In some embodiments, the controllable fuse 1 is disposed between the negative terminal P− of the BMS and the negative terminal of the battery 2, and the protection charging module including the protection charging switch 5, the float charging module including the float charging switch 3, and the high-current charging switch 4 are disposed between the positive terminal P+ of the BMS and the positive terminal of the battery 2.

In some embodiments, a sampling resistor 6 disposed on the negative terminal side of the battery 2 is further included, which is configured to collect a current, and uses a collected sampling current as a charging current, where the charging current is used as one of bases for selecting a charging mode. Instead of the sampling resistor, another current sampling element such as a Hall current sensor is also used.

FIG. 1 further shows a discharge switch 7 disposed on the negative terminal side of the battery 2, which is configured to control turn-on and turn-off between the battery 2 and the negative terminal P− of the BMS. The discharge switch 7 is a semiconductor switching device, and the discharge switch 7 includes a MOSFET or an IGBT. It should be noted that the discharge switch 7 is not involved in application execution of the disclosure. Therefore, the discharge switch 7 is not described herein again.

When a plurality of BMSs with different voltages or capacities are connected in parallel, because of different initial voltages or capacities and considering various factors such as an internal resistance difference of the BMSs, when the BMSs start operating, a BMS with a higher voltage attempts to discharge to a BMS with a lower voltage to balance a voltage difference, which leads to the emergence of a circulating current. The magnitude of the circulating current depends on factors such as a voltage difference, an internal resistance difference, and a capacity and a charging/discharging state of a BMS. A large circulating current may cause damage to a BMS unit, because an excessive current may cause overheating of the battery, damage an internal structure of the battery, and even cause a safety accident. To resolve this problem, according to an embodiment of the disclosure, a charging control method for a BMS is proposed. In addition to a high-current charging mode and a float charging mode, a protection charging mode is also set, and a protection charging condition for entering the protection charging mode is provided. The protection charging condition includes that during an initial set time after the BMS starts operating, the BMS operates in the protection charging mode by default. After the initial set time, the high-current charging mode, the float charging mode, or another charging mode is selected to enter based on a charging state. In the protection charging mode, the BMS controls the protection charging circuit to charge the battery within the set protection charging current threshold. The protection charging current threshold is greater than a float charging current threshold and less than a high-current charging threshold. According to a plurality of tests by the inventors, in an embodiment of the disclosure, the protection charging current threshold is 1.5 A to 2.5 A, preferably 2 A. The initial set time is 1 minute to 30 minutes. In an embodiment of the disclosure, the initial set time is preferably 15 minutes. When a plurality of BMSs with different voltages or capacities are connected in parallel, the BMSs enter the protection charging mode by default when starting operating. The battery is charged within the set protection charging current threshold. Therefore, the circulating current can be gradually reduced, and a voltage difference between the parallel BMSs can be alleviated, to ensure safe and stable running of the BMS systems.

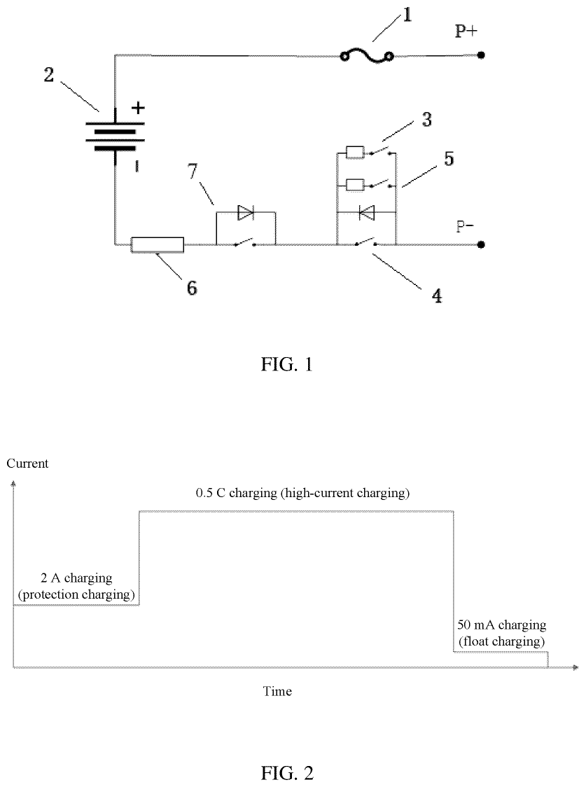

Based on a set protection charging mode, the charging control method for a BMS in this embodiment of the disclosure includes four charging modes: a protection charging mode, a high-current charging mode, a float charging mode, and a stop charging mode. FIG. 2 is a charging mode sequence diagram of a BMS according to an embodiment of the disclosure. A first stage is a protection charging mode, namely, a default charging mode when the BMS starts charging operation. Normally, the charging operation needs to be maintained in this stage within an initial set time. A second stage is a high-current charging mode. The BMS charges a battery within a set high-current charging current threshold range until a maximum single cell voltage reaches a first single cell voltage threshold, and exits the high-current charging mode. A value range of the high-current charging current threshold is 0.1 C to a maximum safe charging current allowed by the battery. A preferred high-current threshold range is greater than or equal to 0.75 times the protection charging current threshold and is less than 0.5 C. C represents a rated capacity of the battery, and the unit is ampere hour. A 0.5 C ratio indicates that the battery is charged at a current of 0.5 times the ampere hour of the rated capacity of the battery. For example, the rated capacity of the battery is 10 Ah, and 0.5 C indicates that a charging current is 5 A. A third stage is float charging mode, and the BMS controls the maximum charging current to be within a set float charging current threshold to charge the battery. In this embodiment of the disclosure, the float charging current threshold is 50 mA. When the battery is fully charged, the charging can be ended. A condition indicating that the battery is fully charged is that an average cell voltage of the BMS in a charging mode is greater than a first average voltage threshold, and a voltage difference between the maximum single cell voltage and a minimum single cell voltage is less than a voltage difference threshold.

Charging states such as a current cell voltage state, a battery level state, and a temperature state are not known at the beginning of charging. Therefore, after entering the protection charging mode by default, a charging operating mode that the BMS needs to enter next needs to be determined with reference to the charging state of the BMS. In an embodiment of the disclosure, the provided charging control method for a BMS may control a charging process of the BMS to switch between the protection charging mode, the high-current charging mode, the float charging mode, and the stop charging mode.

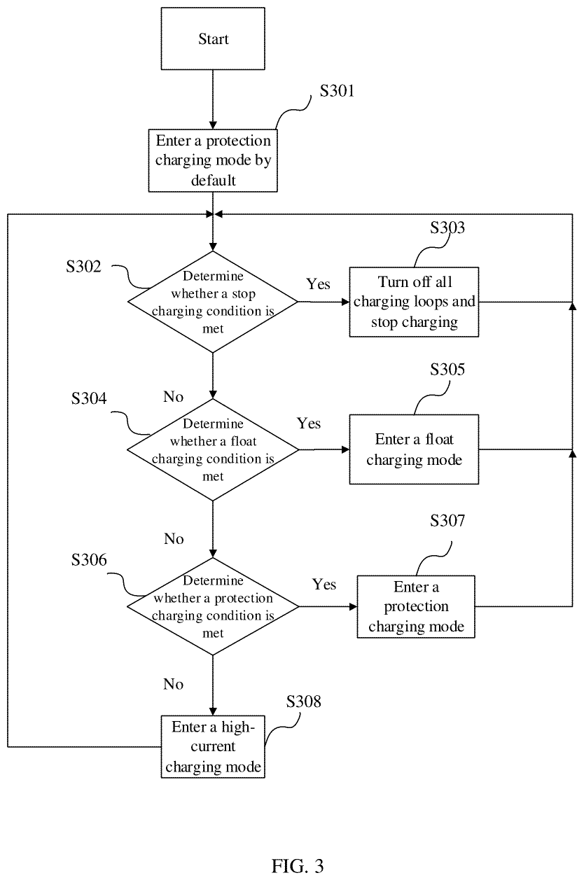

FIG. 3 is a schematic diagram of a mode switching logic according to an embodiment of the disclosure. With reference to FIG. 1 and FIG. 3, the following describes in detail an operating procedure and state switching of a BMS in a charging process.

After the BMS starts charging operation, step S301 is performed. In step S301, when the BMS starts charging operation, the BMS enters the protection charging mode by default. The purpose of this mode is to protect the battery from damage caused by an excessive current at an initial stage of charging. In this mode, the BMS performs the following operations: turning off the high-current charging switch 4, turning on the protection charging switch 5, and turning off the float charging switch 3. In this case, the BMS controls the protection charging circuit to charge the battery within the set protection charging current threshold (for example, 2A).

In step S302, the BMS determines whether a current charging state meets the stop charging condition. These conditions may include a battery voltage reaching a preset charging termination voltage, a battery temperature exceeding a safety threshold, or the like. If the stop charging condition is met, the BMS proceeds to step S303 to perform a stop charging operation. If the stop charging condition is not met, the BMS continues to perform step S304 to further determine a charging state.

In step S303, the BMS turns off all charging loops in response to determining that charging needs to be stopped, including turning off the high-current charging switch 4, the protection charging switch 5, and the float charging switch 3, so that charging is stopped to prevent possible overcharging or other charging-related problems.

In step S304, the BMS determines whether the current charging state meets a float charging condition. The float charging condition means that the battery level is close to full charge, but does not meet a set charge termination condition. If the float charging condition is met, proceed to step S305 to perform an operation related to the float charging mode. If the float charging condition is not met, proceed to step S306 to continue to monitor and determine whether to enter the protection charging mode.

In step S305, the BMS enters the float charging mode in response to determining that it is necessary to enter the float charging mode, that is, the high-current charging switch 4 remains off, the protection charging switch 5 is turned off, and the float charging switch 3 is turned on. In this case, the BMS controls the maximum charging current to charge the battery within the set float charging current threshold (for example, 50 mA).

In step S306, the BMS determines whether the current charging state meets the protection charging condition. If the protection charging condition is met, proceed to step S307. If the protection charging condition is not met, proceed to step S308.

In step S307, the BMS enters the protection charging mode in response to determining that it is necessary to enter the protection charging mode, that is, the high-current charging switch 4 remains off, the protection charging switch 5 is turned on, and the float charging switch 3 is turned off. In this case, the BMS controls the protection charging circuit to charge the battery within the set protection charging current threshold (for example, 2A).

In step S308, if all other conditions are not met, the BMS enters the high-current charging mode. The high-current charging mode is a conventional mode for battery charging, and is applicable to a case in which the battery level is low and there is no other charging restriction. In this mode, the BMS turns on the high-current charging switch 4, so that the battery is quickly charged with a relatively large charging current. Meanwhile, the BMS turns off the protection charging switch 5 and turns off the float charging switch 3.

In some embodiments, in the charging mode in at least one of steps S303, S305, S307, and S308, the BMS sequentially performs step S302 and subsequent determining logic at a set time interval, and performs a corresponding operation based on a determining result of the subsequent determining logic. In an embodiment, the time interval may be 10 ms, 100 ms, 1 s, 10 s, or 1 min. The BMS periodically determines a charging mode to enter, and may adjust the charging mode in a timely manner based on the charging state of the BMS.

In some embodiments, the stop charging condition in step S302 includes one of the following cases:

(10) A cell voltage is excessively high: The maximum cell voltage of a cell of the BMS exceeds a first cell voltage threshold, where the first cell voltage threshold is 3550 mV to 3650 mV. After a plurality of tests, preferably, the first cell voltage threshold is 3600 mV.

(20) The battery is fully charged: The average cell voltage of the BMS exceeds a first average voltage threshold, and a voltage difference between the maximum cell voltage and the minimum cell voltage is less than a voltage difference threshold, where the first average voltage threshold is 3.4 V to 3.5 V. After a plurality of tests, preferably, the first average voltage threshold is 3.45 V; and the voltage difference threshold is 0.05 V to 0.15 V. Preferably, the voltage difference threshold is 0.1 V.

(30) An average cell voltage is excessively high: The average cell voltage of the BMS exceeds a second average voltage threshold, where the second average voltage threshold is 3.55V to 3.65 V. After a plurality of tests, preferably, the second average voltage threshold is 3.6 V.

(40) A cell temperature is excessively high: The maximum cell temperature of the BMS exceeds a first cell temperature threshold, where the first cell temperature threshold is 58° C. to 60° C. After a plurality of tests, preferably, the first cell temperature threshold is 59° C.

(50) The cell temperature is excessively low: The minimum cell temperature of the BMS is less than a third cell temperature threshold, where the third cell temperature threshold is −1° C. to 1° C. After a plurality of tests, preferably, the third cell temperature threshold is 0° C.

In some embodiments, after any one or more of the foregoing five conditions exist, that is, after the BMS enters the stop charging mode, when a release condition corresponding to any one or more of the foregoing established conditions is met, the BMS exits the stop charging mode, and returns to step S302 to continue determining whether the stop charging condition is met. The release condition sequentially corresponding to the foregoing five stop charging conditions include:

(11) The maximum cell voltage of the cell of the BMS is less than a second cell voltage threshold, where the second cell voltage threshold is 3500 mV to 3400 mV. After a plurality of tests, preferably, the second cell voltage threshold is 3450 mV, where the first cell voltage threshold is greater than the second cell voltage threshold.

(21) After discharging, or the state of charge (SOC) of the battery is less than a state of charge threshold, where the state of charge threshold is 93% to 97%. After a plurality of tests, preferably, the state of charge threshold is 95%.

(31) The average cell voltage of the BMS is less than a third average voltage threshold, where the third average voltage threshold is 3.4 V to 3.5 V. Preferably, the third average voltage threshold is 3.45 V, where the second average voltage threshold is greater than the third average voltage threshold.

(41) The maximum temperature of the cell of the BMS is lower than a second cell temperature threshold, where the second cell temperature threshold is 55° C. to 57° C. After a plurality of tests, preferably, the second cell temperature threshold is 57° C., where the first cell temperature threshold is greater than the second cell temperature threshold.

(51) The minimum temperature of the cell of the BMS exceeds a fourth cell temperature threshold, where the fourth cell temperature threshold is 3° C. to 7° C. After a plurality of tests, preferably, the fourth cell temperature threshold is 5° C. The third cell temperature threshold is less than the fourth cell temperature threshold.

In some embodiments, the float charging condition in step S304 includes: The maximum single cell voltage is greater than or equal to the first single cell voltage threshold. In some embodiments, if the BMS is in the float charging mode, when the maximum single cell voltage is less than the second single cell voltage threshold, the BMS exits the float charging mode in step S305, that is, the float charging condition in step S304 is met and then released, and then the BMS returns to step S302 to determine whether the stop charging condition is met. The first single cell voltage threshold is 3.47 V to 3.53 V, and preferably, the first single cell voltage threshold is 3.5 V; and the second single cell voltage threshold is 3.4 V to 3.45 V, and preferably, the second single cell voltage threshold is 3.43 V. The first single cell voltage threshold is greater than the second single cell voltage threshold. In an embodiment, after detecting that the float charging condition is released, it is not necessary to immediately exit the float charging mode and return to step S302. Instead, after detecting that the float charging condition is released and reaching the set time interval, the BMS returns to step S302 to perform periodic determining to obtain the next charging mode to enter, and then the BMS exits the current float charging mode.

In a charging control circuit of the BMS, a sampling circuit is configured to sample and measure signals such as a current and a voltage. A BMS charging strategy is formulated and adjusted based on data provided by the sampling circuit, for example, the magnitude of the charging current and the length of charging time are adjusted. If the sampling circuit is short-circuited, there is no or only a very small voltage difference between two ends of a sampling resistor, so that the sampling current is displayed as 0 or close to 0. In this case, the sampling current cannot represent a real charging current, and cannot reflect a real charging condition of the BMS. Therefore, the charging strategy fails, and BMS overcharging may be caused. For this problem, according to an embodiment of the disclosure, in step S306, the BMS determines whether the protection charging condition is met. Therefore, before entering the high-current charging mode, if a fault that the sampling circuit is short-circuited is detected, the BMS selects to enter the protection charging mode to prevent overcharging. On the other hand, in the charging mode of at least one of step S303, S305, S307, and S308, in a process in which the BMS sequentially performs step S302 and subsequent determining logic at a specified time interval and performs an operation corresponding to the determining logic, the fault that the sampling circuit is short-circuited may be detected in a timely manner, and the protection charging mode is selected to enter, to prevent overcharging.

In step S306, the protection charging condition is that the charging current is less than a first charging current threshold. The first charging current threshold is related to the protection charging current threshold, and may be 10% to 90% of the protection charging current threshold. In an embodiment of the disclosure, the first charging current threshold is preferably set to 75% of the protection charging current threshold. For example, if the protection charging current threshold is 2 A, the first charging current threshold is 1.5 A. In a case in which the float charging condition is not met, that the charging current is set to be less than the first charging current threshold is used as a condition for entering the protection charging mode, to avoid the problem that the charging strategy of the BMS fails because the sampling circuit is short-circuited and an actual charging current cannot be collected.

According to an embodiment of the disclosure, in step S306, the determining whether the protection charging condition is met may further include: When the charging current is greater than the high-current charging current threshold, the BMS enters the protection charging mode. In this way, a problem that the charging circuit is short-circuited in the high-current charging mode can be overcome, and the high-current charging current threshold can be conveniently modified in a subsequent project without changing hardware, so that the charging solution is more flexible. For example, a BMS charging current may be modified to be greater than 1.0 C and the BMS enters the protection charging mode.

In some embodiments, a condition for exiting the protection charging mode (that is, a release condition for the protection charging condition) is that the corresponding protection charging condition no longer exists. For example, if the protection charging condition is that the BMS charging current is less than the first charging current threshold, or the BMS charging current is greater than the high-current charging current threshold, or the BMS enters the protection charging mode by default within an initial set time after the BMS starts operating, the release condition of the corresponding protection charging condition is that the BMS charging current is greater than or equal to the first charging current threshold and is less than the high-current charging current threshold, and duration in which the BMS continues to operate in the protection charging mode exceeds the set time. After exiting the protection charging mode, return to step S302 to determine whether the stop charging condition is met. In an embodiment, after detecting that the release condition of the protection charging condition is met, it is not necessary to immediately exit the protection charging mode and return to step S302. Instead, after detecting that the release condition of the protection charging condition is met and reaching the set time interval, the BMS returns to step S302 to perform periodic determining to obtain the next charging mode to enter, and then the BMS exits the current protection charging mode.

In a process of charging the BMS, in the float charging mode and the protection charging mode, if the charging circuit is short-circuited, the charging current increases abnormally, which may easily cause a rapid rise in cell voltage, resulting in BMS overcharging and cell damage. To resolve this problem, according to an embodiment of the disclosure, if the BMS is in the float charging mode of step S305, when the charging current is greater than the float charging current threshold by a first set difference based on the first set difference, it is determined that the charging circuit is faulty. In this case, the BMS controls the controllable fuse 1 to fuse the circuit. If the difference between the charging current and the float charging current threshold is less than or equal to the first set difference, it is determined that the charging current is in a safe range, the BMS may continue to operate until the battery is fully charged, and the BMS fuses the controllable fuse 1 to cut off the current. A value of the first set difference is related to precision of sampling, by the sampling circuit, the charging current in the float charging mode. In an embodiment of the disclosure, the first set difference is preferably 0.95 A. For example, in the float charging mode, the charging current should be kept at the float charging current threshold of about 50 mA. If the charging current is greater than 1 A in this case, it may be determined that the charging circuit is faulty. Therefore, the problem that the charging circuit is short-circuited in the float charging mode can be resolved. According to another embodiment of the disclosure, if the BMS is in the protection charging mode of step S307, when the charging current is greater than the protection charging current threshold by a second set difference based on the second set difference, it is determined that the charging circuit is faulty. In this case, the BMS controls the controllable fuse 1 to fuse the circuit. If the difference between the charging current and the protection charging current threshold is less than or equal to the second set difference, it is determined that the charging current is in a safe range, the BMS may continue to operate until the battery is fully charged, and the BMS fuses the controllable fuse 1 to cut off the current. A value of the second set difference is related to precision of sampling, by the sampling circuit, the charging current in the protection charging mode. In an embodiment of the disclosure, the second set difference is preferably 0.8 A. For example, in the protection charging mode, the charging current should not be greater than the protection charging current threshold of 2 A. If the charging current is greater than 2.8 A, it may be determined that the charging circuit is faulty. Therefore, the problem that the charging circuit is short-circuited in the protection charging mode can be resolved.

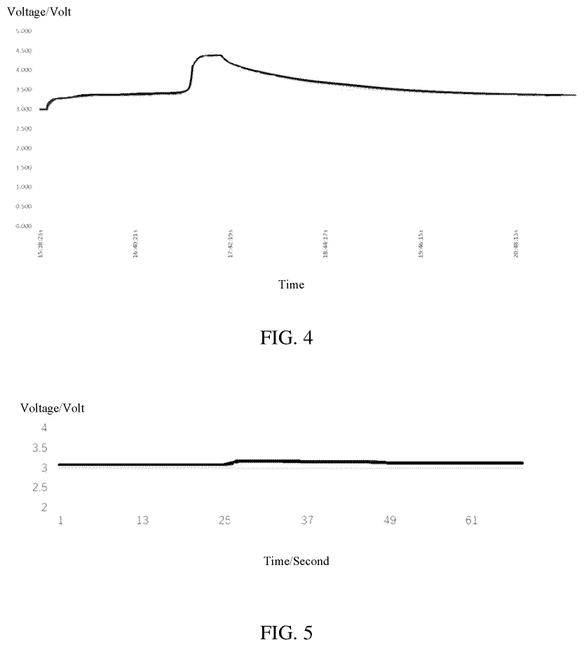

A result of a UL test performed by using an existing BMS charging solution is shown in FIG. 4. In an overcharging experiment of the UL test, the rated capacity of the BMS is 6 Ah, and the rated charging current is 3 A. First, the BMS is discharged to a cell voltage of about 3 V, and then the charging circuit is short-circuited. A current that is 1.1 times the rated current 3 A of the BMS, i.e. 3.3 A, is used to charge the BMS. It can be learned from FIG. 4 that when the BMS stops charging, the cell voltage reaches about 4.5 V that exceeds a safe cell voltage range 2.0 V to 4.0 V, leading to an authentication failure. In an existing BMS charging solution, after the maximum single cell voltage of the BMS reaches 3.5 V, the BMS enters the float charging mode, and the charging current is detected to be 3.3 A in the float charging mode, which exceeds a 1 A limit. Then, a MCU sends a drive signal to fuse the controllable fuse. The sum of a detection time and a fuse time of the controllable fuse is about 20 seconds, and a cell voltage exceeds a cell platform voltage. In this case, the charging current of 3.3 A causes a rapid rise in cell voltage, resulting in a test failure.

A result of a UL test performed according to the BMS charging control solution of the disclosure is shown in FIG. 5. The BMS is discharged to a cell voltage of about 3 V, and then the charging circuit is short-circuited. A current that is 1.1 times the rated current of the BMS is used to charge the BMS, and the charging starts from the 26th second. When the BMS is in the protection charging mode, when it is detected that the charging current is greater than 2.8 A, it is determined that the charging circuit is faulty in the 31st second, a MCU sends a drive signal to fuse the controllable fuse, the controllable fuse is fused in the 47th second, and the BMS stops charging. When the charging is stopped, the maximum voltage and minimum voltage of a cell are within a safe voltage range of 2.0 V to 4.0 V of the cell, leading to an authentication success.

In another embodiment of the disclosure, a computer-readable storage medium is further provided. Computer programs or executable instructions are stored on the computer-readable storage medium. When the computer programs or the executable instructions are executed, the BMS charging control as described in the foregoing embodiments is implemented. Implementation principles are similar, and details are not described herein again. In this embodiment of the disclosure, the computer-readable storage medium may be any tangible medium that can store data and may be read by a computing apparatus. Examples of the computer-readable storage medium include a hard disk drive, a network attached storage (NAS), a read-only memory, a random access memory, a CD-ROM, a CD-R, a CD-RW, a magnetic tape, and another optical or non-optical data storage apparatus. The computer-readable storage medium may also include a computer-readable medium distributed on a network-coupled computer system, so that computer programs or instructions may be stored and executed in a distributed manner.

In still another embodiment of the disclosure, an electronic device is further provided, including a processor and a memory, where the memory is configured to store executable instructions that can be executed by the processor, the processor is configured to execute the executable instructions stored on the memory, and when the executable instructions are executed, the charging control method for a BMS according to the foregoing embodiments is implemented. Implementation principles are similar, and details are not described herein again.

The reference to “various embodiments”, “some embodiments”, “one embodiment”, “an embodiment”, or the like in the specification means that specific features, structures, or properties described with reference to the embodiments are included in at least one embodiment. Therefore, the phrase “in various embodiments”, “in some embodiments”, “in one embodiment”, “in an embodiment”, or the like does not necessarily refer to the same embodiment throughout the specification. In addition, the specific features, structures, or properties may be combined in any suitable manner in one or more embodiments. Therefore, the specific features, structures, or properties shown or described with reference to one embodiment may be combined, in whole or in part without limitation, with the features, structures, or properties of one or more other embodiments, provided that the combination is not non-logical or inoperable.

The terms “comprise” and “comprising” as well as term expressions with a similar meaning in the specification are intended to cover a non-exclusive inclusion, for example, a process, a method, a system, a product, or a device that includes a series of steps or units is not limited to the listed steps or units, but optionally further includes an unlisted step or unit, or optionally further includes another step or unit inherent to the process, the method, the product, or the device. “An” or “a” does not exclude multiple cases. In addition, the elements in the accompanying drawings of the present application are merely used for schematic description, and are not drawn in a scale.

Although the disclosure has been described by using preferred embodiments, the disclosure is not limited to the embodiments described herein, and includes various changes and variations without departing from the scope of the disclosure.

### DESCRIPTION OF REFERENCE NUMERALS

1—controllable fuse;
2—battery;
3—float charging switch;
4—high-current charging switch;
5—protection charging switch;
6—sampling resistor;

1-11. (canceled)

12. A charging control method for a battery management system, the method comprising:
electrically connecting the battery management system in parallel with at least one other battery management system having an initial voltage or capacity different from that of the battery management system;
selecting, based on a detected charging state of the battery management system, a charging mode from among a high-current charging mode in which a measured charging current supplied to a battery is maintained within a predetermined high-current charging threshold range, a float charging mode in which the measured charging current supplied to the battery is maintained within a predetermined float charging current threshold, a stop charging mode in which a charging circuit of the battery management system is opened, or a protection charging mode in which the measured charging current supplied to the battery is maintained within a predetermined protection charging current threshold that is greater than the predetermined float charging current threshold and less than the predetermined high-current charging threshold range;
during an initial set time period after startup of the battery management system, operating in the protection charging mode to limit a circulating current between the battery management system and the at least one other battery management system to a value within the predetermined protection charging current threshold, thereby reducing a voltage difference between the battery management systems prior to entering the high-current charging mode; and
after the initial set time period, selecting, based at least in part on whether the measured charging current satisfies a protection charging condition, a measured maximum single cell voltage satisfies a float charging condition, or a measured battery temperature satisfies a stop charging condition, to enter one of the protection charging mode, the high-current charging mode, the float charging mode, or the stop charging mode.

13. The charging control method of claim 12, further comprising:
operating in the protection charging mode by default during the initial set time period after startup of the battery management system when the battery management system is electrically connected in parallel with at least one other battery management system having an initial voltage or capacity different from that of the battery management system; and
operating in the protection charging mode in place of the high-current charging mode in response to detecting at least one of:
the measured charging current supplied to the battery being less than a first charging current threshold indicative of a sampling circuit short, or
the measured charging current supplied to the battery being greater than the predetermined high-current charging threshold range indicative of a charging circuit short.

14. The charging control method of claim 12, wherein, when the battery management system is electrically connected in parallel with at least one other battery management system having an initial voltage or capacity different from that of the battery management system, the method comprises operating in the protection charging mode during the initial set time period after startup to limit a circulating current between the battery management systems to a value within the predetermined protection charging current threshold, thereby reducing a voltage difference between the battery management systems prior to entering the high-current charging mode.

15. The charging control method of claim 12, wherein, during the initial set time period in the protection charging mode, the method comprises charging the battery at the predetermined protection charging current threshold to gradually reduce a voltage difference between the battery and the at least one other battery management system connected in parallel, the voltage difference being a cause of circulating currents capable of overheating or damaging the battery, a reduction in voltage difference occurring prior to transitioning to the high-current charging mode.

16. The charging control method of claim 12, wherein the predetermined protection charging current threshold is less than the predetermined high-current charging threshold range and greater than the predetermined float charging current threshold, each of the thresholds defining the maximum charging current supplied to the battery in the corresponding charging mode.

17. The charging control method of claim 12, further comprising:
operating in the protection charging mode for the initial set time period immediately after the battery management system begins a charging operation;
after the initial set time period, determining at least one of the measured charging current supplied to the battery, a measured maximum single cell voltage, a measured average cell voltage, or a measured battery temperature; and
selecting one of the high-current charging mode, the float charging mode, the protection charging mode, or the stop charging mode based at least in part on whether the measured charging current satisfies a protection charging condition, the measured maximum single cell voltage satisfies a float charging condition, or the measured battery temperature satisfies a stop charging condition.

18. The charging control method of claim 12, wherein, prior to entering the high-current charging mode, the method comprises:
determining whether a protection charging condition is satisfied, the protection charging condition comprising at least one of the measured charging current supplied to the battery being less than a first charging current threshold determined based on the predetermined protection charging current threshold; the measured charging current supplied to the battery being greater than the predetermined high-current charging threshold range; or detection of a startup state of the battery management system; and
operating in the protection charging mode instead of the high-current charging mode when the protection charging condition is satisfied.

19. The charging control method of claim 12, further comprising:
determining whether a stop charging condition is satisfied and, when satisfied, operating in the stop charging mode;
when the stop charging condition is not satisfied, determining whether a float charging condition is satisfied and, when satisfied, operating in the float charging mode;
when neither the stop charging condition nor the float charging condition is satisfied, determining whether a protection charging condition is satisfied and, when satisfied, operating in the protection charging mode; and
when none of the stop charging condition, the float charging condition, or the protection charging condition is satisfied, operating in the high-current charging mode.

20. The charging control method of claim 19, further comprising periodically re-evaluating whether the stop charging condition is satisfied at a fixed time interval while operating in the high-current charging mode, the protection charging mode, or the float charging mode.

21. A charging control apparatus for a battery management system, comprising:
a first charging path disposed between a positive terminal and a negative terminal of the battery management system, the first charging path comprising:
a controllable fuse configured to disconnect a charging circuit of the battery management system in response to a control signal,
a battery, and
a charging switch comprising a semiconductor switching device configured to control a maximum charging current through the charging switch to be within a predetermined high-current charging threshold range;
a protection charging module connected in parallel with two ends of the charging switch, the protection charging module being configured to control a maximum charging current through the protection charging module to be within a predetermined protection charging current threshold;
a float charging module connected in parallel with the two ends of the charging switch, the float charging module being configured to control a maximum charging current through the float charging module to be within a predetermined float charging current threshold;
wherein only one of the charging switch, the protection charging module, and the float charging module is turned on at any given time.

22. The charging control apparatus of claim 21, wherein the protection charging module is configured to be turned on by default during an initial set time period after startup of the battery management system when the battery management system is electrically connected in parallel with at least one other battery management system having a different initial voltage or capacity, the protection charging module being further configured to be turned on in place of the charging switch in response to detection of at least one of:
a measured charging current supplied to the battery being less than a first charging current threshold indicative of a sampling circuit short, or
a measured charging current supplied to the battery being greater than a high-current charging threshold indicative of a charging circuit short,
wherein the protection charging module limits the maximum charging current supplied to the battery to a predetermined protection charging current threshold that is greater than a float charging current threshold and less than the high-current charging threshold.

23. The charging control apparatus of claim 21, wherein the charging control apparatus is configured, when the battery management system is electrically connected in parallel with at least one other battery management system having a different initial voltage or capacity, to operate in the protection charging mode during an initial set time period after startup to limit a circulating current between the battery management systems to a value within the predetermined protection charging current threshold, thereby reducing a voltage difference between the battery management systems before entering the high-current charging mode.

24. The charging control apparatus of claim 21, wherein the charging control apparatus is configured, during an initial set time period in the protection charging mode, to charge the battery at the predetermined protection charging current threshold to gradually reduce a voltage difference between the battery and at least one other battery management system connected in parallel, the voltage difference being a cause of circulating currents that can overheat or damage the battery, a reduction in voltage difference occurring prior to transitioning to the high-current charging mode.

25. The charging control apparatus of claim 21, wherein the charging control apparatus is configured to operate in a plurality of charging modes comprising:
a high-current charging mode in which the charging switch is turned on and a maximum charging current supplied to the battery is within the high-current charging threshold range;
a protection charging mode in which the protection charging module is turned on and the maximum charging current supplied to the battery is within the protection charging current threshold;
a float charging mode in which the float charging module is turned on and the maximum charging current supplied to the battery is within the float charging current threshold; and
a stop charging mode in which the controllable fuse disconnects the charging circuit.

26. The charging control apparatus of claim 25, wherein the protection charging current threshold is less than the high-current charging threshold and greater than the float charging current threshold, each of the thresholds defining the maximum charging current supplied to the battery in the corresponding charging mode.

27. The charging control apparatus of claim 21, wherein the charging control apparatus is configured to:
operate in the protection charging mode for an initial set time period immediately after the battery management system begins a charging operation,
and after the initial set time period, determine at least one of a measured charging current supplied to the battery, a maximum single cell voltage, an average cell voltage, or a battery temperature,
and select one of the high-current charging mode, the float charging mode, the protection charging mode, or a stop charging mode based at least in part on whether the measured charging current satisfies a protection charging condition, the maximum single cell voltage satisfies a float charging condition, or the battery temperature satisfies a stop charging condition.

28. The charging control apparatus of claim 21, wherein the charging control apparatus is configured, prior to entering the high-current charging mode, to determine whether a protection charging condition is satisfied, the protection charging condition comprising at least one of:
a measured charging current supplied to the battery being less than a first charging current threshold determined based on the protection charging current threshold,
a measured charging current supplied to the battery being greater than the high-current charging threshold range, or
detection of a startup state of the battery management system, and
wherein when the protection charging condition is satisfied, to operate in the protection charging mode instead of the high-current charging mode.

21. The charging control apparatus of claim 21, wherein the charging control apparatus is configured to:
determine whether a stop charging condition is satisfied and, when satisfied, operate in the stop charging mode;
when the stop charging condition is not satisfied, determine whether a float charging condition is satisfied and, when satisfied, operate in the float charging mode;
when neither the stop charging condition nor the float charging condition is satisfied, determine whether a protection charging condition is satisfied and, when satisfied, operate in the protection charging mode; and
when none of the stop charging condition, the float charging condition, or the protection charging condition is satisfied, operate in the high-current charging mode.

30. The charging control apparatus of claim 21, wherein the charging control apparatus is configured to determine that the protection charging condition is satisfied when a measured charging current supplied to the battery is greater than the high-current charging threshold range, the high-current charging threshold range defining a maximum charging current supplied to the battery for operation in the high-current charging mode.

31. A method of controlling charging in a battery management system, the method comprising:
initiating operation of a battery management system by, during a startup period, supplying a charging current to a battery managed by the battery management system at a first current level, the first current level corresponding to a protection charging current;
monitoring an actual charging current supplied to the battery managed by the battery management system;
wherein the battery management system is connected in parallel with one or more other battery management systems managing other batteries, and the actual charging current supplied to the battery varies based on circulating current resulting from voltage differences between the battery and the other batteries;
determining whether the actual charging current deviates from an expected charging current associated with the protection charging current by at least a predetermined margin, the deviation indicating a fault condition; and
in response to determining that the fault condition is present, disconnecting the battery from a charging circuit using a controllable fuse;
wherein the battery management system further determines whether the actual charging current satisfies a low-current condition during a non-float charging mode, the low-current condition comprising the actual charging current being less than a lower current threshold, and delays entry into a high-current charging mode in response to the low-current condition being satisfied, to avoid overcharging due to a sampling circuit fault.
